(19) United States
(12) Patent Application Publication
(10) Pub. No.: US 2023/0313073 A1
(43) Pub. Date: Oct. 5, 2023

(54) AUTOMATIC DISHWASHING FORMULATION WITH DISPERSANT COPOLYMER BLEND

(71) Applicants: Rohm and Haas Company, Collegeville, PA (US); Dow Silicones Corporation, Midland, MI (US)

(72) Inventors: Scott Backer, Phoenixville, PA (US); Clara Leclaire, Uccle (BE)

(21) Appl. No.: 18/022,346

(22) PCT Filed: Sep. 15, 2021
(86) PCT No.: PCT/US2021/050349

§ 371 Date: Feb. 21, 2023

Related U.S. Application Data
(60) Provisional application No. 63/080,043, filed on Sep. 18, 2020.

(51) Int. Cl. C11D 3/37; C11D 3/395; C11D 3/36; C11D 3/386; C11D 3/10; C11D 11/00

(52) U.S. Cl. CPC C11D 3/3761; C11D 3/3951; C11D 3/361; C11D 3/38609; C11D 3/10; C11D 11/0035

(57) ABSTRACT

An automatic dishwashing composition is provided, comprising: builder; nonionic surfactant; first dispersant polymer comprising: 60 to 98 wt % of structural units of formula I, wherein each R¹ is independently selected from a hydrogen and a —CH₃ group; and 2 to 40 wt % of structural units of formula II, wherein each R² is independently selected from a —C₁₋₄ alkyl group and wherein each R³ is independently selected from a hydrogen and a methyl group; and second dispersant polymer comprising: 60 to 98 wt % of structural units of formula I; wherein each R¹ is independently selected from a hydrogen and a —CH₃ group; and 2 to 40 wt % of structural units of formula II; wherein each R² is independently selected from a —C₁₋₄ alkyl group and wherein each R³ is independently selected from a hydrogen and a methyl group; wherein the first dispersant polymer and the second dispersant polymer are different.

The present invention relates to a blend of dispersant copolymers for use in automatic dish washing formulations. In particular, the present invention relates to automatic dishwashing compositions comprising: (A) a builder; (B) a nonionic surfactant; (C) a first dispersant polymer comprising: (i) 60 to 98 wt %, based on solids weight of the first dispersant polymer, of structural units of formula I

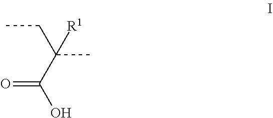

wherein each R¹ is independently selected from a hydrogen and a —CH₃ group; and (ii) 2 to 40 wt %, based on solids weight of the first dispersant polymer, of structural units of formula II

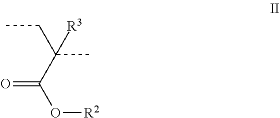

wherein each R² is independently selected from a —C₁₋₄ alkyl group and wherein each R³ is independently selected from a hydrogen and a methyl group; and (D) a second dispersant polymer comprising: (i) 60 to 98 wt %, based on solids weight of the second dispersant polymer, of structural units of formula I, wherein each R¹ is independently selected from a hydrogen and a —CH₃ group; and (ii) 2 to 40 wt %, based on solids weight of the second dispersant polymer, of structural units of formula II, wherein each R² is independently selected from a —C₁₋₄ alkyl group and wherein each R³ is independently selected from a hydrogen and a methyl group; wherein the first dispersant polymer and the second dispersant polymer are different.

Automatic dishwashing compositions are generally recognized as a class of detergent compositions distinct from those used for fabric washing or water treatment. Automatic dishwashing compositions are expected by users to produce a spotless and film-free appearance on washed articles after a complete cleaning cycle.

Phosphate-free automatic dishwashing compositions are increasingly desirable. Phosphate-free automatic dishwashing compositions typically rely on non-phosphate builders, such as salts of citrate, carbonate, silicate, disilicate, bicarbonate, aminocarboxylates and others to sequester calcium and magnesium from hard water, and upon drying, leave an insoluble visible deposit.

Currently available polymers employed in phosphate-free automatic dishwashing compositions to combat the formation of undesirable deposits on glassware include polyacrylic acid polymers and copolymers of acrylic acid and 2-acrylamido-2-methylpropane sulfonic acid (AMPS) and sodium styrene sulfonate (SSS). Polyacrylic acid polymers, however, fail to prevent certain film deposits on glassware (e.g., magnesium disilicate and calcium phosphonate scales), which present as transparent blue to blue/white films on glassware and brown films on stainless steel. Copolymers of acrylic acid with sulfonated monomers, while excellent at silicate and phosphonate scale prevention, such copolymers are not particularly effective at carbonate scale prevention. In addition, such polymers tend to have a negative impact on spotting, requiring the use of strong chelants or specialized surfactants, which lead to undesirable increases in the overall cost of the dishwashing composition.

Accordingly there remains a need for new dispersant polymers and dispersant polymer blends for use in automatic dish washing formulations. In particular, there remains a need for new dispersant polymer blends for use in automatic dish washing formulations, wherein the dispersant polymer blends provide overall shine performance, particularly when incorporated into phosphate-free formulations.

The present invention provides an automatic dishwashing composition, comprising: (A) a builder; (B) a nonionic surfactant; (C) a first dispersant polymer comprising: (i) 60 to 98 wt %, based on solids weight of the first dispersant polymer, of structural units of formula I

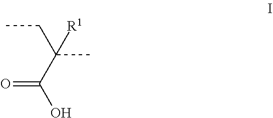

wherein each R¹ is independently selected from a hydrogen and a —CH₃ group; and (ii) 2 to 40 wt %, based on solids weight of the first dispersant polymer, of structural units of formula II

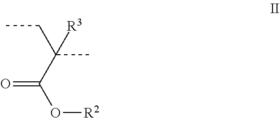

wherein each R² is independently selected from a —C₁₋₄ alkyl group and wherein each R³ is independently selected from a hydrogen and a methyl group; and (D) a second dispersant polymer comprising: (i) 60 to 98 wt %, based on solids weight of the second dispersant polymer, of structural units of formula I, wherein each R¹ is independently selected from a hydrogen and a —CH₃ group; and (ii) 2 to 40 wt %, based on solids weight of the second dispersant polymer, of structural units of formula II, wherein each R² is independently selected from a —C₁₋₄ alkyl group and wherein each R³ is independently selected from a hydrogen and a methyl group; wherein the first dispersant polymer and the second dispersant polymer are different.

The present invention provides an automatic dishwashing composition, comprising: (A) a builder; (B) a nonionic surfactant; (C) a first dispersant polymer comprising: (i) 60 to 80 wt %, based on solids weight of the first dispersant polymer, of structural units of formula I, wherein each R¹ is independently selected from a hydrogen and a —CH₃ group; and (ii) 20 to 40 wt %, based on solids weight of the first dispersant polymer, of structural units of formula II, wherein each R² is independently selected from a —C₁₋₄ alkyl group and wherein each R³ is independently selected from a hydrogen and a methyl group; and (D) a second dispersant polymer comprising: (i) >80 to 98 wt %, based on solids weight of the second dispersant polymer, of structural units of formula I, wherein each R¹ is independently selected from a hydrogen and a —CH₃ group; and (ii) 2 to <20 wt %, based on solids weight of the second dispersant polymer, of structural units of formula II, wherein each R² is independently selected from a —C₁₋₄ alkyl group and wherein each R³ is independently selected from a hydrogen and a methyl group; wherein the first dispersant polymer and the second dispersant polymer are different.

The present invention provides an automatic dishwashing composition, comprising: (A) 40 to 70 wt %, based on dry weight of the automatic dishwashing composition, of a builder, wherein the builder is selected from the group consisting of carbonates, bicarbonates, citrates, silicates and mixtures thereof; (B) 5 to 17.5 wt %, based on dry weight of the automatic dishwashing composition, of a nonionic surfactant; wherein the nonionic surfactant comprises a mixture of nonionic alcohol alkoxylates; (C) 2 to 4 wt %, based on dry weight of the automatic dishwashing composition, of a first dispersant polymer comprising: (i) 60 to 80 wt %, based on solids weight of the first dispersant polymer, of structural units of formula I, wherein each R¹ is independently selected from a hydrogen and a —CH₃ group; and (ii) 20 to 40 wt %, based on solids weight of the first dispersant polymer, of structural units of formula II, wherein each R² is independently selected from a —C₁₋₄ alkyl group and wherein each R³ is independently selected from a hydrogen and a methyl group; (D) 2 to 4 wt %, based on dry weight of the automatic dishwashing composition, of a second dispersant polymer comprising: (i) >80 to 98 wt %, based on solids weight of the second dispersant polymer, of structural units of formula I, wherein eachR¹ is independently selected from a hydrogen and a —CH₃ group; and (ii) 2 to <20 wt %, based on solids weight of the second dispersant polymer, of structural units of formula II, wherein each R² is independently selected from a —C₁₋₄ alkyl group and wherein each R³ is independently selected from a hydrogen and a methyl group; (E) 2 to 7.5 wt %, based on the dry weight of the automatic dishwashing composition, of a phosphonate; (F) 5 to 12 wt %, based on the dry weight of the automatic dishwashing composition, of a bleaching agent, wherein the bleaching agent is selected from the group consisting of sodium percarbonate and sodium perborate; (G) 2.5 to 7.5 wt %, based on the dry weight of the automatic dishwashing composition, of a bleach activator; wherein the bleach activator is tetraacetylethylenediamine; (H) 3 to 6 wt %, based on the dry weight of the automatic dishwashing composition, of a protease; and (I) 2.5 to 4.5 wt %, based on the dry weight of the automatic dishwashing composition, of an amylase.

The present invention provides a method of cleaning an article in an automatic dishwashing machine, comprising: providing at least one article; providing an automatic dishwashing composition according to the present invention; and applying the automatic dishwashing composition to the at least one article.

### DETAILED DESCRIPTION

Surprisingly, it has been found that, the dispersant polymer blends of the present invention when incorporated into automatic dishwashing compositions (particularly phosphate-free automatic dishwashing compositions), the dispersant polymer blends of the present invention as particularly described herein surprisingly give good overall shine performance (i.e., sum of filming and spotting performance on multiple substrates—glass tumblers, wine glasses, PMMA glasses, SS Butter dishes) versus conventional dispersant polymers.

Unless otherwise indicated, ratios, percentages, parts, and the like are by weight. Weight percentages (or wt %) in the composition are percentages of dry weight, i.e., excluding any water that may be present in the composition. Percentages of monomer units in the polymer are percentages of solids weight, i.e., excluding any water present in a polymer emulsion.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polystyrene standards. GPC techniques are discussed in detail in Modem Size Exclusion Chromatography, W. W. Yau, J. J. Kirkland, D. D. Bly; Wiley-lnterscience, 1979, and in A Guide to Materials Characterization and Chemical Analysis, J. P. Sibilia; VCH, 1988, p. 81-84. Weight average molecular weights are reported herein in units of Daltons.

The term “phosphate-free” as used herein and in the appended claims means compositions containing ≤1 wt % (preferably, ≤0.5 wt %; more preferably, ≤0.2 wt %; still more preferably, ≤0.01 wt %; yet still more preferably, ≤0.001 wt %; most preferably, less than the detectable limit) of phosphate (measured as elemental phosphorus).

The term “structural units” as used herein and in the appended claims refers to the remnant of the indicated monomer; thus a structural unit of (meth)acrylic acid is illustrated:

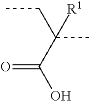

wherein the dotted lines represent the points of attachment to the polymer backbone and whereR¹ is a hydrogen for structural units of acrylic acid and a —CH₃ group for structural units of methacrylic acid.

Preferably, the automatic dishwashing composition of the present invention, comprises: (A) a builder (preferably, 1 to 95 wt % (more preferably, ≥20 wt %; yet more preferably, ≥30 wt %; still more preferably, ≥40 wt %; most preferably, ≥50 wt %; preferably, ≤90 wt %; more preferably, ≤80 wt %; still more preferably, ≤70 wt %; most preferably, ≤60 wt %), based on the dry weight of the automatic dishwashing composition, of the builder)(preferably, wherein the builder includes a mixture of at least one carbonate and at least one citrate); (B) a nonionic surfactant (preferably, 0.2 to 25 wt % (more preferably, 2.5 to 20 wt %; most preferably, 5 to 17.5 wt %), based on the dry weight of the automatic dishwashing composition, of the nonionic surfactant)(preferably, wherein the nonionic surfactant is a nonionic alcohol alkoxylate); (C) a first dispersant polymer (preferably, 0.1 to 12 wt % (more preferably, 0.5 to 10 wt %; still more preferably, 1 to 6 wt %; most preferably, 2 to 4 wt %), based on the dry weight of the automatic dishwashing composition, of the first dispersant polymer) comprising: (i) 60 to 98 wt % (preferably, 60 to 80 wt %; more preferably, 65 to 77.5 wt %; most preferably, 70 to 75 wt %), based on solids weight of the first dispersant polymer, of structural units of formula I

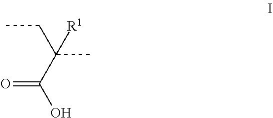

wherein each R¹ is independently selected from a hydrogen and a —CH₃ group; and (ii) 2 to 40 wt % (preferably, 20 to 40 wt %; more preferably, 22.5 to 35 wt %; most preferably, 25 to 30 wt %), based on solids weight of the first dispersant polymer, of structural units of formula II

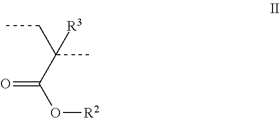

wherein each R² is independently selected from a —C₁₋₄ alkyl group and wherein each R³ is independently selected from a hydrogen and a methyl group; and (D) a second dispersant polymer (preferably, 0.1 to 12 wt % (more preferably, 0.5 to 10 wt %; still more preferably, 1 to 6 wt %; most preferably, 2 to 4 wt %), based on the dry weight of the automatic dishwashing composition, of the second dispersant polymer) comprising: (i) 60 to 98 wt % (preferably, >80 to 98 wt %; more preferably, 85 to 97.5 wt %; most preferably, 88 to 95 wt %), based on solids weight of the second dispersant polymer, of structural units of formula I; wherein each R¹ is independently selected from a hydrogen and a —CH₃ group; and (ii) 2 to 40 wt % (preferably, 2 to <20 wt %; more preferably, 2.5 to 15 wt %; most preferably, 5 to 12 wt %), based on solids weight of the second dispersant polymer, of structural units of formula II; wherein each R² is independently selected from a —C₁₋₄ alkyl group and wherein each R³ is independently selected from a hydrogen and a methyl group; wherein the first dispersant polymer and the second dispersant polymer are different.

Preferably, the automatic dishwashing composition of the present invention, comprises a builder. Preferably, the automatic dishwashing composition of the present invention, comprises a builder, wherein the builder comprises a mixture of at least one carbonate and at least one citrate. More preferably, the automatic dishwashing composition of the present invention comprises a builder, wherein the builder comprises a mixture of at least one carbonate, at least one citrate and at least one citrate. Still more preferably, the automatic dishwashing composition of the present invention, comprises: a builder, wherein the builder comprises a mixture of sodium carbonate, sodium percarbonate and sodium citrate. Most preferably, the automatic dishwashing composition of the present invention, comprises: a builder, wherein the builder comprises a mixture of sodium carbonate, sodium percarbonate, sodium silicate and sodium citrate.

Preferably, the automatic dishwashing composition of the present invention, comprises: 1 to 95 wt %, based on the dry weight of the automatic dishwashing composition, of a builder. Preferably, the automatic dishwashing composition of the present invention, comprises: ≥1 wt % (preferably, ≥20 wt %; more preferably, ≥30 wt %; yet more preferably, ≥40 wt %; most preferably, ≥50 wt %), based on the dry weight of the automatic dishwashing composition, of the builder. Preferably, the automatic dishwashing composition of the present invention, comprises: ≤90 wt % (preferably, ≤80 wt %; more preferably, ≤70 wt %; most preferably, ≤60 wt %), based on the dry weight of the automatic dishwashing composition, of the builder. Weight percentages of carbonate, citrate and silicate builders are based on the actual weights of the salts, including metal ions.

The term “carbonate(s)” as used herein and in the appended claims refers to alkali metal or ammonium salts of carbonate, bicarbonate, percarbonate, and/or sesquicarbonate. Preferably, the carbonate used in the automatic dishwashing composition (if any) is selected from the group consisting of carbonate salts of sodium, potassium and lithium (more preferably, salts of sodium or potassium; most preferably, salts of sodium). Percarbonate used in the automatic dishwashing composition (if any) is selected from salts of sodium, potassium, lithium and ammonium (more preferably, salts of sodium or potassium; most preferably, salts of sodium). Most preferably, the carbonate used in the automatic dishwashing composition (if any) includes at least one of sodium carbonate, sodium bicarbonate and sodium percarbonate. Preferably, when the builder used in the automatic dishwashing composition of the present invention includes carbonate, the automatic dishwashing composition preferably, comprises 0 to 97 wt % (preferably, 10 to 75 wt %; more preferably, 20 to 60 wt %; most preferably 25 to 50 wt %), based on the dry weight of the automatic dishwashing composition, of carbonate.

The term “citrate(s)” as used herein and in the appended claims refers to alkali metal citrates. Preferably, the citrate used in the automatic dishwashing composition (if any) is selected from the group consisting of citrate salts of sodium, potassium and lithium (more preferably, salts of sodium or potassium; most preferably, salts of sodium). More preferably, the citrate used in the automatic dishwashing composition (if any) is sodium citrate. Preferably, when the builder used in the automatic dishwashing composition of the present invention includes citrate, the automatic dishwashing composition preferably, comprises 0 to 97 wt % (preferably, 5 to 75 wt %; more preferably, 10 to 50 wt %; most preferably 15 to 30 wt %), based on the dry weight of the automatic dishwashing composition, of the citrate.

The term “silicate(s)” as used herein and in the appended claims refers to alkali metal silicates. Preferably, the silicate used in the automatic dishwashing composition (if any) is selected from the group consisting of silicate salts of sodium, potassium and lithium (more preferably, salts of sodium or potassium; most preferably, salts of sodium). More preferably, the silicate used in the automatic dishwashing composition (if any) is sodium disilicate. Preferably, the builder used in the automatic dishwashing composition of the present invention includes a silicate. Preferably, when the builder used in the automatic dishwashing composition of the present invention includes a silicate, the automatic dishwashing composition preferably, comprises 0 to 97 wt % (preferably, 0.1 to 10 wt %; more preferably, 0.5 to 7.5 wt %; most preferably 0.75 to 4 wt %), based on the dry weight of the automatic dishwashing composition, of the silicate.

Preferably, the automatic dishwashing composition of the present invention, comprises: 0.2 to 25 wt % (preferably, 2.5 to 20 wt %; more preferably, 5 to 17.5 wt %), based on the dry weight of the automatic dishwashing composition, of a nonionic surfactant. More preferably, the automatic dishwashing composition of the present invention, comprises: 0.2 to 25 wt % (preferably, 2.5 to 20 wt %; more preferably, 5 to 17.5 wt %), based on the dry weight of the automatic dishwashing composition, of the nonionic surfactant; wherein the surfactant comprises at least one of an alcohol alkoxylate. Most preferably, the automatic dishwashing composition of the present invention, comprises: 0.2 to 25 wt % (preferably, 2.5 to 20 wt %; more preferably, 5 to 17.5 wt %), based on the dry weight of the automatic dishwashing composition, of the nonionic surfactant; wherein the nonionic surfactant is a blend of alcohol alkoxylate surfactants (preferably, a blend of at least two different nonionic alcohol alkoxylate surfactants; more preferably, a blend of two to three different nonionic alcohol alkoxylate surfactants).

Preferably, the automatic dishwashing composition of the present invention, comprises 0.2 to 25 wt % (preferably, 2.5 to 20 wt %; more preferably, 5 to 17.5 wt %), based on dry weight of the automatic dishwashing composition, of a nonionic surfactant; wherein the nonioinic surfactant is of formula III

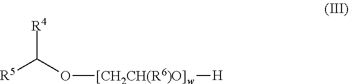

wherein w is an average of 5 to 45 (preferably, 7 to 40); wherein R⁴ is selected from the group consisting of a hydrogen and a linear or branched C₁₋₂₀ alkyl group (preferably, a hydrogen, and a linear or branched C₁₋₁₅ alkyl group; more preferably, a hydrogen and a linear C₁₋₁₅ alkyl group); wherein R⁵ is a linear or branched C₁₋₂₀ alkyl group (preferably, a linear C₁₋₂₀ alkyl group); wherein each R⁶ is independently selected from the group consisting of a hydrogen, a methyl group, an ethyl group, a n-propyl group, an iso-propyl group, a n-butyl group, a 2-butyl group and a 2-methyl-2-butyl group (preferably, a hydrogen, a methyl group and an ethyl group); and with the proviso that sum of the total number of carbon atoms in R⁴ and R⁵ is 5 to 21 (preferably, 6 to 20 carbon atoms; more preferably, 7 to 18)(preferably, wherein the nonionic surfactant is a blend of at least two different nonionic surfactants according to formula III; more preferably, wherein the nonionic surfactant is a blend of two to three different nonionic surfactants according to formula III). More preferably, the automatic dishwashing composition of the present invention, comprises: a concentrated hard surface cleaning composition, comprising 0.2 to 25 wt % (preferably, 2.5 to 20 wt %; more preferably, 5 to 17.5 wt %), based on dry weight of the automatic dishwashing composition, of a nonionic surfactant; wherein the nonionic surfactant includes a nonionic surfactant of formula III; wherein w is an average of 7 to 40; wherein R⁴ is selected from the group consisting of a hydrogen and a linear C₁₋₁₅ alkyl group; wherein R⁵ is a linear or branched C₁₋₂₀ alkyl group; and with the proviso that the sum of the total number of carbon atoms in R⁴ and R⁵ is 6 to 20. Most preferably, the 0.2 to 25 wt % (preferably, 2.5 to 20 wt %; more preferably, 5 to 17.5 wt %), based on dry weight of the automatic dishwashing composition, of a nonionic surfactant; wherein the nonioinic surfactant includes a nonionic surfactant of formula III; wherein w is an average of 7 to 40; wherein R⁴ is selected from the group consisting of a hydrogen and a linear C₁₋₁₅ alkyl group; wherein R⁵ is a linear C₁₋₂₀ alkyl group; and with the proviso that the sum of the total number of carbon atoms in R⁴ and R⁵ is 7 to 18.

Preferably, the automatic dishwashing composition of the present invention, includes a first dispersant polymer. More preferably, the automatic dishwashing composition of the present invention, includes: 0.1 to 12 wt %, based on the dry weight of the automatic dishwashing composition, of a first dispersant polymer. Still more preferably, the automatic dishwashing composition of the present invention, includes 0.5 to 10 wt %, based on the dry weight of the automatic dishwashing composition, of a first dispersant polymer. Yet more preferably, the automatic dishwashing composition of the present invention, includes 1 to 6 wt %, based on the dry weight of the automatic dishwashing composition, of a first dispersant polymer. Most preferably, the automatic dishwashing composition of the present invention, includes 2 to 4 wt %, based on the dry weight of the automatic dishwashing composition, of a first dispersant polymer.

Preferably, the first dispersant polymer used in the automatic dishwashing composition of the present invention comprises 60 to 98 wt % (preferably, 60 to 80 wt %; more preferably, 65 to 77.5 wt %; most preferably, 70 to 75 wt %), based on solids weight of the first dispersant polymer, of structural units of formula I, wherein each R¹ is independently selected from a hydrogen and a —CH₃ group. More preferably, the first dispersant polymer used in the automatic dishwashing composition of the present invention comprises 60 to 98 wt % (preferably, 60 to 80 wt %; more preferably, 65 to 77.5 wt %; most preferably, 70 to 75 wt %), based on solids weight of the first dispersant polymer, of structural units of formula I; wherein R¹ is a hydrogen in 75 to 100 mol% (preferably, 90 to 100 mol%; more preferably, 98 to 100 mol%; still more preferably, >99 mol%; most preferably, 100 mol%) of the structural units of formula I in the first dispersant polymer.

Preferably, the first dispersant polymer used in the automatic dishwashing composition of the present invention comprises 2 to 40 wt % (preferably, 20 to 40 wt %; more preferably, 22.5 to 35 wt %; most preferably, 25 to 30 wt %), based on solids weight of the first dispersant polymer, of structural units of formula II, wherein each R² is independently selected from a —C₁₋₄ alkyl group (preferably, a methyl group, an ethyl group and a butyl group; more preferably, an ethyl group and a butyl group; most preferably, an ethyl group) and wherein each R³ is independently selected from a hydrogen and a methyl group. More preferably, the first dispersant polymer used in the automatic dishwashing composition of the present invention comprises 2 to 40 wt % (preferably, 20 to 40 wt %; more preferably, 22.5 to 35 wt %; most preferably, 25 to 30 wt %), based on solids weight of the first dispersant polymer, of structural units of formula II, wherein each R² is independently selected from an ethyl group and a butyl group and wherein each R³ is independently selected from a hydrogen and a methyl group. Most preferably, the first dispersant polymer used in the automatic dishwashing composition of the present invention comprises 2 to 40 wt % (preferably, 20 to 40 wt %; more preferably, 22.5 to 35 wt %; most preferably, 25 to 30 wt %), based on solids weight of the first dispersant polymer, of structural units of formula II, wherein R² is an ethyl group in 75 to 100 mol % (preferably, 90 to 100 mol %; more preferably, 98 to 100 mol %; most preferably, 100 mol %) of the structural units of formula II in the first dispersant polymer; and wherein R³ is a hydrogen in 75 to 100 mol % (preferably, 90 to 100 mol %; more preferably, 98 to 100 mol %; most preferably, 100 mol %) of the structural units of formula II in the first dispersant polymer.

Preferably, the first dispersant polymer used in the automatic dishwashing composition of the present invention has a weight average molecular weight of 4,000 to 50,000 Daltons. More preferably, the first dispersant polymer used in the automatic dishwashing composition of the present invention has a weight average molecular weight of 4,200 to 25,000 Daltons. Still more preferably, the first dispersant polymer used in the automatic dishwashing composition of the present invention has a weight average molecular weight of 4,500 to 15,000 Daltons. Most preferably, the first dispersant polymer used in the automatic dishwashing composition of the present invention has a weight average molecular weight of 4,750 to 10,000 Daltons.

Preferably, the automatic dishwashing composition of the present invention, includes a second dispersant polymer. More preferably, the automatic dishwashing composition of the present invention, includes: 0.1 to 12 wt %, based on the dry weight of the automatic dishwashing composition, of a second dispersant polymer. Still more preferably, the automatic dishwashing composition of the present invention, includes 0.5 to 10 wt %, based on the dry weight of the automatic dishwashing composition, of a second dispersant polymer. Yet more preferably, the automatic dishwashing composition of the present invention, includes 1 to 6 wt %, based on the dry weight of the automatic dishwashing composition, of a second dispersant polymer. Most preferably, the automatic dishwashing composition of the present invention, includes 2 to 4 wt %, based on the dry weight of the automatic dishwashing composition, of a second dispersant polymer.

Preferably, the second dispersant polymer used in the automatic dishwashing composition of the present invention comprises 60 to 98 wt % (preferably, >80 to 98 wt %; more preferably, 85 to 97.5 wt %; most preferably, 88 to 95 wt %), based on solids weight of the second dispersant polymer, of structural units of formula I, wherein each R¹ is independently selected from a hydrogen and a —CH₃ group. More preferably, the second dispersant polymer used in the automatic dishwashing composition of the present invention comprises 60 to 98 wt % (preferably, >80 to 98 wt %; more preferably, 85 to 97.5 wt %; most preferably, 88 to 95 wt %), based on solids weight of the second dispersant polymer, of structural units of formula I, wherein R¹ is a hydrogen in 75 to 100 mol % (preferably, 90 to 100 mol %; more preferably, 98 to 100 mol %; still more preferably, ≥99 mol %; most preferably, 100 mol %) of the structural units of formula I in the second dispersant polymer.

Preferably, the second dispersant polymer used in the automatic dishwashing composition of the present invention comprises 2 to 40 wt % (preferably, 2 to <20 wt %; more preferably, 2.5 to 15 wt %; most preferably, 5 to 12 wt %), based on solids weight of the second dispersant polymer, of structural units of formula II, wherein each R² is independently selected from a —C₁₋₄ alkyl group (preferably, a methyl group, an ethyl group and a butyl group; more preferably, an ethyl group and a butyl group; most preferably, an ethyl group) and wherein each R³ is independently selected from a hydrogen and a methyl group. More preferably, the second dispersant polymer used in the automatic dishwashing composition of the present invention comprises 2 to 40 wt % (preferably, 2 to <20 wt %; more preferably, 2.5 to 15 wt %; most preferably, 5 to 12 wt %), based on solids weight of the second dispersant polymer, of structural units of formula II, wherein each R² is independently selected from an ethyl group and a butyl group and wherein each R³ is independently selected from a hydrogen and a methyl group. Most preferably, the second dispersant polymer used in the automatic dishwashing composition of the present invention comprises 2 to 40 wt % (preferably, 2 to <20 wt %; more preferably, 2.5 to 15 wt %; most preferably, 5 to 12 wt %), based on solids weight of the second dispersant polymer, of structural units of formula II, wherein R² is an ethyl group in 75 to 100 mol % (preferably, 90 to 100 mol %; more preferably, 98 to 100 mol %; most preferably, 100 mol %) of the structural units of formula II in the second dispersant polymer; and wherein R³ is a hydrogen in 75 to 100 mol % (preferably, 90 to 100 mol %; more preferably, 98 to 100 mol %; most preferably, 100 mol %) of the structural units of formula II in the second dispersant polymer.

Preferably, the second dispersant polymer used in the automatic dishwashing composition of the present invention has a weight average molecular weight of 1,000 to <4,000 Daltons. More preferably, the second dispersant polymer used in the automatic dishwashing composition of the present invention has a weight average molecular weight of 1,200 to 3,750 Daltons. Still more preferably, the second dispersant polymer used in the automatic dishwashing composition of the present invention has a weight average molecular weight of 1,500 to 3,500 Daltons. Most preferably, the second dispersant polymer used in the automatic dishwashing composition of the present invention has a weight average molecular weight of 1,750 to 3,250 Daltons.

Preferably, both the first dispersant polymer and the second dispersant polymer used in the automatic dishwashing composition of the present invention comprise ≤0.3 wt % (more preferably, ≤0.1 wt %; still more preferably, ≤0.05 wt %; yet still more preferably, ≤0.03 wt %; most preferably, ≤0.01 wt %) of structural units of multi-ethylenically unsaturated crosslinking monomer.

Preferably, both the first dispersant polymer and the second dispersant polymer used in the automatic dishwashing composition of the present invention comprise ≤1 wt % (preferably, ≤0.5 wt %; more preferably, ≤0.001 wt %; still more preferably, ≤0.0001 wt %; most preferably, <the detectable limit) of structural units of sulfonated monomer. More preferably, both the first dispersant polymer and the second dispersant polymer used in the automatic dishwashing composition of the present invention comprise ≤1 wt % (preferably, ≤0.5 wt %; more preferably, ≤0.001 wt %; still more preferably, ≤0.0001 wt %; most preferably, <the detectable limit) of structural units of sulfonated monomer selected from the group consisting of 2-acrylamido-2-methylpropane sulfonic acid (AMPS), 2-methacrylamido-2-methylpropane sulfonic acid, 4-styrenesulfonic acid, vinylsulfonic acid, 3-allyloxy sulfonic acid, 2-hydroxy-1-propane sulfonic acid (HAPS), 2-sulfoethyl(meth)acrylic acid, 2-sulfopropyl(meth)acrylic acid, 3-sulfopropyl(meth)acrylic acid, 4-sulfobutyl(meth)acrylic acid and salts thereof. Most preferably, both the first dispersant polymer and the second dispersant polymer used in the automatic dishwashing composition of the present invention comprise ≤1 wt % (preferably, ≤0.5 wt %; more preferably, ≤0.001 wt %; still more preferably, ≤0.0001 wt %; most preferably, <the detectable limit) of structural units of 2-acrylamido-2-methylpropane sulfonic acid (AMPS) monomer.

The automatic dishwashing composition of the present invention, optionally further comprises an additive. Preferably, the automatic dishwashing composition of the present invention, further comprises an additive selected from the group consisting of a phosphonate (e.g., HEDP); an alkaline source; a bleaching agent (e.g., sodium percarbonate, sodium perborate); a bleach activator (e.g., tetraacetylethylenediamine (TAED)); a bleach catalyst (e.g., manganese(II) acetate, cobalt(II) chloride, bis(TACN)magnesium trioxide diacetate); an enzyme (e.g., protease, amylase, lipase, or cellulase); a foam suppressant; a coloring agent; a fragrance; an additional builder; an antibacterial agent; a filler; a deposit control polymer and mixtures thereof. More preferably, the automatic dishwashing composition of the present invention, further comprises an additive, wherein the additive is selected from the group consisting of a phosphonate, a bleaching agent, a bleach activator, an enzyme, a filler and mixtures thereof. Still more preferably, the automatic dishwashing composition of the present invention, further comprises an additive, wherein the additive includes a phosphonate (e.g., HEDP); a bleaching agent (e.g., sodium percarbonate, sodium perborate); a bleach activator (e.g., tetraacetylethylenediamine (TAED)) and an enzyme (e.g., protease, amylase, lipase, or cellulase). Most preferably, the automatic dishwashing composition of the present invention, further comprises an additive, wherein the additive includes a phosphonate, wherein the phosphonate is selected from the group consisting of 1-hydroxyethylidene-1,1-diphosphonic acid (HEDP) and salts thereof; a bleaching agent, wherein the bleaching agent includes sodium percarbonate; a bleach activator, wherein the bleach activator includes tetraacetylethylenediamine (TAED); and an enzyme, wherein the enzyme includes a protease and an amylase.

Preferably, the automatic dishwashing composition of the present invention, optionally further comprises 0 to 15 wt % (more preferably, 0.1 to 12.5 wt %; still more preferably, 0.5 to 10 wt %; most preferably, 2 to 7.5 wt %), based on the dry weight of the automatic dishwashing composition, of a phosphonate. More preferably, the automatic dishwashing composition of the present invention, optionally further comprises 0 to 15 wt % (more preferably, 0.1 to 12.5 wt %; still more preferably, 0.5 to 10 wt %; most preferably, 2 to 7.5 wt %), based on the dry weight of the automatic dishwashing composition, of a phosphonate; wherein the phosphonate has a weight average molecular weight of ≤1,000 Daltons. Still more preferably, the automatic dishwashing composition of the present invention, optionally further comprises 0 to 15 wt % (more preferably, 0.1 to 12.5 wt %; still more preferably, 0.5 to 10 wt %; most preferably, 2 to 7.5 wt %), based on the dry weight of the automatic dishwashing composition, of a phosphonate; wherein the phosphonate comprises at least one of 1-hydroxyethylidene-1,1-diphosphonic acid (HEDP) and a salt of 1-hydroxyethylidene-1,1-diphosphonic acid. Most preferably, the automatic dishwashing composition of the present invention, optionally further comprises 0 to 15 wt % (more preferably, 0.1 to 12.5 wt %; still more preferably, 0.5 to 10 wt %; most preferably, 2 to 7.5 wt %), based on the dry weight of the automatic dishwashing composition, of a phosphonate; wherein the phosphonate is selected from the group consisting of 1-hydroxyethylidene-1,1-diphosphonic acid (HEDP) and salts thereof.

Fillers included in tablets or powders are inert, water-soluble substances, typically sodium or potassium salts (e.g., sodium sulfate, potassium sulfate, sodium chloride, potassium cloride). In tablets and powders, fillers are typically present in amounts ranging from 0 wt % to 75 wt %. Fillers included in gel formulations typically include those mentioned for use in tablets and powders and also water. Fragrances, dyes, foam suppressants, enzymes and antibacterial agents usually total no more than 10 wt %, alternatively no more than 5 wt %, of the automatic dishwashing composition.

The automatic dishwashing composition of the present invention, optionally further comprises: an alkaline source. Suitable alkaline sources include, without limitation, alkali metal carbonates and alkali metal hydroxides, such as sodium or potassium carbonate, bicarbonate, sesquicarbonate, sodium, lithium, or potassium hydroxide, or mixtures of the foregoing. Sodium hydroxide is preferred. The amount of alkaline source in the automatic dishwashing composition of the present invention (if any) is at least 1 wt % (preferably, at least 20 wt %) and up to 80 wt % (preferably, up to 60 wt %), based on the dry weight of the automatic dishwashing composition.

The automatic dishwashing composition of the present invention, optionally further comprises: a bleaching agent (e.g., sodium percarbonate). The amount of the bleaching agent in the automatic dishwashing composition of the present invention (if any) is preferably at a concentration of 1 to 25 wt % (preferably, 2.5 to 20 wt %; more preferably, 5 to 12 wt %), based on the dry weight of the automatic dishwashing composition.

The automatic dishwashing composition of the present invention, optionally further comprises: a bleach activator (e.g., tetraacetylethylenediamine (TAED)). The amount of the bleach activator in the automatic dishwashing composition of the present invention (if any) is preferably at a concentration of 1 to 10 wt % (preferably, 2.5 to 7.5 wt %), based on the dry weight of the automatic dishwashing composition.

Preferably, the automatic dishwashing composition of the present invention, optionally further comprises: an enzyme (e.g., protease and amylase). More preferably, the automatic dishwashing composition of the present invention, optionally further comprises: 0 to 20 wt % (preferably, 2 to 15 wt %; more preferably, 4 to 12 wt %), based on the dry weight of the automatic dishwashing composition, of an enzyme. Most preferably, the automatic dishwashing composition of the present invention, further comprises: 1 to 10 wt % (preferably, 2 to 7.5 wt %; more preferably, 3 to 6 wt %), based on the dry weight of the automatic dishwashing composition, of a protease; and 1 to 10 wt % (preferably, 2 to 7.5 wt %; more preferably, 2.5 to 4.5 wt %), based on the dry weight of the automatic dishwashing composition, of an amylase.

Preferably, the automatic dishwashing composition of the present invention comprises ≤1 wt % (preferably, ≤0.5 wt %; more preferably, ≤0.2 wt %; still more preferably, ≤0.1 wt %; yet still more preferably, ≤0.01 wt %; most preferably, <the detectable limit), based on the dry weight of the automatic dishwashing composition, of phosphate (measured as elemental phosphorus). Preferably, the automatic dishwashing composition of the present invention is phosphate free.

Preferably, the automatic dishwashing composition of the present invention comprises ≤1 wt % (preferably, ≤0.5 wt %; more preferably, ≤0.2 wt %; still more preferably, ≤0.1 wt %; yet still more preferably, ≤0.01 wt %; most preferably, <the detectable limit), based on the dry weight of the automatic dishwashing composition, of builders selected from the group consisting of nitrilotriacetic acid; ethylenediaminetetraacetic acid; diethylenetriaminepentaacetic acid; glycine-N,N-diacetic acid; methyl glycine-N,N-diacetic acid; 2-hydroxyethyliminodiacetic acid; glutamic acid-N,N-diacetic acid; 3-hydroxy-2,2′-iminodissuccinate; S,S-ethylenediaminedisuccinate aspartic acid-diacetic acid; N,N′-ethylene diamine disuccinic acid; iminodisuccinic acid; aspartic acid; aspartic acid-N,N-diacetic acid; beta-alaninediacetic acid; polyaspartic acid; salts thereof and mixtures thereof. Most preferably, the automatic dishwashing composition of the present invention contains 0 wt % of builders selected from the group consisting of nitrilotriacetic acid; ethylenediaminetetraacetic acid; diethylenetriaminepentaacetic acid; glycine-N,N-diacetic acid; methyl glycine-N,N-diacetic acid; 2-hydroxyethyliminodiacetic acid; glutamic acid-N,N-diacetic acid; 3-hydroxy-2,2′-iminodissuccinate; S,S-ethylenediaminedisuccinate aspartic acid-diacetic acid; N,N′-ethylene diamine disuccinic acid; iminodisuccinic acid; aspartic acid; aspartic acid-N,N-diacetic acid; beta-alaninediacetic acid; polyaspartic acid; salts thereof and mixtures thereof.

Preferably, the automatic dishwashing composition of the present invention has a pH (at 1 wt % in water) of at least 7 (preferably, ≥9; more preferably, ≥9.5). Preferably, the automatic dishwashing composition of the present invention has a pH (at 1 wt % in water) of no greater than 13.

Preferably, the automatic dishwashing composition of the present invention can be formulated in any typical form, e.g., as a tablet, powder, block, monodose, sachet, paste, liquid or gel. The automatic dishwashing compositions of the present invention are useful for cleaning ware, such as eating and cooking utensils, dishes, in an automatic dishwashing machine.

Preferably, the automatic dishwashing composition of the present invention are suitable for use under typical operating conditions. For example, when used in an automatic dishwashing machine, typical water temperatures during the washing process preferably are from 20° C. to 85° C., preferably 30° C. to 70° C. Typical concentrations for the automatic dishwashing composition as a percentage of total liquid in the dishwasher preferably are from 0.1 to 1 wt %, preferably from 0.2 to 0.7 wt %. With selection of an appropriate product form and addition time, the automatic dishwashing compositions of the present invention may be present in the prewash, main wash, penultimate rinse, final rinse, or any combination of these cycles.

Preferably, the method of cleaning an article in an automatic dishwashing machine of the present invention, comprises: providing at least one article (e.g., cookware, bakeware, tableware, dishware, flatware and/or glassware); providing an automatic dishwashing composition of the present invention; and applying the automatic dishwashing composition to the at least one article (preferably, in an automatic dishwasher).

Some embodiments of the present invention will now be described in detail in the following Examples.

The weight average molecular weight, Mw; number average molecular weight, MN; and polydispersity (PDI) values reported in the Examples were measured by gel permeation chromatography (GPC) on an Agilent 1100 series LC system equipped with an Agilent 1100 series refractive index. Samples were dissolved in HPCL grade THF/FA mixture (100:5 volume/volume ratio) at a concentration of approximately 9 mg/mL and filtered through at 0.45 μm syringe filter before injection through a 4.6×10 mm Shodex KF guard column, a 8.0×300 mm Shodex KF 803 column, a 8.0×300 mm Shodex KF 802 column and a 8.0×100 mm Shodex KF-D column. A flow rate of 1 mL/min and temperature of 40° C. were maintained. The columns were calibrated with narrow molecular weight PS standards (EasiCal PS-2, Polymer Laboratories, Inc.).

### DISPERSANT POLYMER DP1-DP2: DISPERSANT POLYMER COMPOSITIONS

Dispersant polymer compositions used herein had the composition and weight average molecular weight as noted in TABLE 1.

TABLE 1

| | Monomer Feed composition (wt %) | | Weight average |
|---|---|---|---|
| Example | Acrylic acid | Ethyl Acrylate | molecular weight |
| DP1 | 92 | 8 | 2,500 Daltons |
| DP2 | 73 | 27 | 6,500 Daltons |

### COMPARATIVE EXAMPLES C1-C3 AND EXAMPLES 1-2: DISHWASHING PERFORMANCE

Dishwashing compositions were prepared in each of Comparative Examples C1-C3 and Examples 1-2 having the component formulations identified in TABLE 2. The protease used in each of the component formulations was Savinase® 12T protease available from Novozymes. The amylase used in each of the component formulations was Stainzyme® 12T amylase available from Novozymes.

TABLE 2

| | Concentration on solids basis (wt %) | | | | |
|---|---|---|---|---|---|
| Ingredient | C1 | C2 | C3 | 1 | 2 |
| Sodium Carbonate | 29.1 | 29.1 | 30.6 | 29.1 | 30.6 |
| Sodium Citrate | 21.2 | 21.2 | 22.3 | 21.2 | 22.3 |
| Sodium Percarbonate | 8.8 | 8.8 | 9.3 | 8.8 | 9.3 |
| TAED | 3.6 | 3.6 | 3.7 | 3.6 | 3.7 |
| Secondary alcohol ethoxylate^{a} | 8.8 | 8.8 | 4.6 | 8.8 | 4.6 |
| Branched alcohol alkoxylate^{b} | 2.9 | 2.9 | 1.5 | 2.9 | 1.5 |
| Alcohol alkoxylate^{c} | 3.6 | 3.6 | 3.7 | 3.6 | 3.7 |
| HEDP^{d} | 5.3 | 5.3 | 5.6 | 5.3 | 5.6 |
| Amylase | 3.8 | 3.8 | 5.0 | 3.8 | 5.0 |
| Protease | 4.7 | 4.7 | 5.0 | 4.7 | 5.0 |
| Sodium Disilicate | 2.4 | 2.4 | 2.5 | 2.4 | 2.5 |
| Dispersant Polymer DP1 | — | 5.8 | — | 2.9 | 3.1 |
| Dispersant Polymer DP2 | 5.8 | — | — | 2.9 | 3.1 |
| Polyacrylic acid^{e} | — | — | 3.1 | — | — |
| Copolymer of acrylic and sulfonic | — | — | 3.1 | — | — |
| acids^{f} | | | | | |

^{a}Tergitol ™ 15-S-7 nonionic surfactant available from The Dow Chemical Company.
^{b}Ecosurf ™ LFE-1410 nonionic surfactant available from The Dow Chemical Company.
^{c}Ecosurf ™ Bright 1 nonionic surfactant available from The Dow Chemical Company.
^{d}Cublen K8514G organophosphonate available from Zschimmer & Schwarz.
^{e}Acusol ™ 445NG dispersant polymer available from The Dow Chemical Company.
^{f}Acusol ™ 588G dispersant polymer available from The Dow Chemical Company.

### PROCEDURE FOR PREPARING FOOD SOIL

The IKW food soil burden described in TABLE 3 was prepared by the following procedure.
a) Combine vegetable oil and whole egg and mix thoroughly with a hand blend until the mixture is homogeneous
b) Add ketchup and mustard, still stirring vigorously.
c) Melt the fats, allow to cool to approx. 40° C., then add to the mixture b) and blend in well.
d) Stir in cream and milk in c).
e) Add the powdered solid constituents in d) and mix everything to a smooth paste.

Finally, put 50 g of the soil mix into 100 mL glass pots. Deep freeze them and keep them in the freezer until required.

TABLE 3

| Ingredient | wt % |
|---|---|
| Sunflower oil | 31.6 |
| Margarine (Plantafin) | 6.3 |
| Lard (Blanc de Boeuf) | 6.3 |
| Deep-frying fat (Solo) | 6.3 |
| Whole egg | 15.8 |
| 35% fat cream | 9.4 |
| Whole milk, pasteurized, 3.5% fat | 6.3 |
| Potato starch | 2.2 |
| Gravy (Fond de veau, Knorr) | 1.7 |
| Wheat flour | 0.6 |
| Quark powder | 0.6 |
| Benzoic acid >99.9% | 0.3 |
| Tomato ketchup | 6.3 |
| Mustard | 6.3 |

### DISHWASHING TEST CONDITIONS

Machine: Miele SS-ADW, Model G1222SC Labor 2 (GSL2). Wash at 50° C.-8 min/rinse 65° C. Water: 600 ppm total hardness, Ca:Mg=3:1. Ratio of Deionized water with 300 ppm Na-bicarbonate (TH=37° FH, TAC=23° FH). Food soil: 50 g of the composition noted in TABLE 3 was introduced to the wash liquor frozen in a cup. Each dishwashing composition from Comparative Examples C1-C2 and Example 1 were tested, dosed at 17 g per wash.

### FILMING AND SPOTTING EVALUATION

After 5 and 15 wash cycles under the above dishwashing test conditions, the glass tumblers, wine glasses, PMMA glasses and stainless steel butter dishes were dried in open air. After drying in open air following the 5^{th} and 15^{th} wash, filming and spotting ratings were determined by trained evaluators by observations in a light box with controlled illumination from below. The glass tumblers, wine glasses, PMMA glasses and stainless steel butter dishes were rated for filming and spotting according to ASTM method ranging from 1 (no film/spots) to 5 (heavily filmed/spotted). An average value of 1 to 5 for filming and spotting was determined as reported in TABLES 4 and 5 for the 5 cycle score and the 15 cycle score, respectively.

TABLE 4

| | Five Cycle Score | | | | | | | | |
|---|---|---|---|---|---|---|---|---|---|
| | Glass | | Wine | | PMMA | | SS Butter | | |
| | Tumblers | | Glasses | | Glasses | | Dishes | | Overall |
| Composition | Film | Spot | Film | Spot | Film | Spot | Film | Spot | Shine |
| Comp. Example C1 | 2.0 | 3.0 | 2.0 | 2.0 | 2.5 | 4.5 | 2.0 | 1.5 | 19.5 |
| Comp. Example C2 | 3.0 | 1.0 | 4.0 | 3.5 | 3.0 | 4.5 | 3.0 | 1.5 | 23.5 |
| Example 1 | 2.0 | 1.0 | 1.5 | 1.0 | 2.5 | 4.5 | 1.5 | 1.5 | 15.5 |

TABLE 5

| | Fifteen Cycle Score | | | | | | | | |
|---|---|---|---|---|---|---|---|---|---|
| | Glass | | Wine | | PMMA | | SS Butter | | |
| | Tumblers | | Glasses | | Glasses | | Dishes | | Overall |
| Composition | Film | Spot | Film | Spot | Film | Spot | Film | Spot | Shine |
| Comp. Example C1 | 2.0 | 3.0 | 2.0 | 2.0 | 2.0 | 4.5 | 2.0 | 3.5 | 21.0 |
| Comp. Example C2 | 4.0 | 1.0 | 4.0 | 2.5 | 2.0 | 4.5 | 4.0 | 1.0 | 23.0 |
| Example 1 | 2.0 | 1.5 | 1.5 | 1.0 | 2.0 | 4.5 | 2.0 | 1.5 | 16.0 |

### DISHWASHING TEST CONDITIONS

Machine: Miele SS-ADW, Model G1222SC Labor 2 (GSL2). Wash at 65° C.-8 min/rinse 65° C. Water: 600 ppm total hardness, Ca:Mg=3:1. Ratio of Deionized water with 300 ppm Na-bicarbonate (TH=37° FH, TAC=23° FH). Food soil: 50 g of the composition noted in TABLE 3 was introduced to the wash liquor frozen in a cup. Each dishwashing composition from Comparative Examples C1-C2 and Example 1 were tested, dosed at 17 g per wash.

### FILMING AND SPOTTING EVALUATION

After 5 wash cycles under the above dishwashing test conditions, the glass tumblers, wine glasses, PMMA glasses and stainless steel butter dishes were dried in open air. After drying in open air following the 5^{th} wash, filming and spotting ratings were determined by trained evaluators by observations in a light box with controlled illumination from below. The glass tumblers, wine glasses, PMMA glasses and stainless steel butter dishes were rated for filming and spotting according to ASTM method ranging from 1 (no film/spots) to 5 (heavily filmed/spotted). An average value of 1 to 5 for filming and spotting was determined as reported in TABLE 6.

TABLE 6

| | Five Cycle Score | | | | | | | | |
|---|---|---|---|---|---|---|---|---|---|
| | Glass | | Wine | | PMMA | | SS Butter | | |
| | Tumblers | | Glasses | | Glasses | | Dishes | | Overall |
| Composition | Film | Spot | Film | Spot | Film | Spot | Film | Spot | Shine |
| Comp. Example C1 | 1.5 | 1.5 | 1.5 | 1.0 | 2.5 | 3.5 | 2.0 | 1.0 | 14.5 |
| Comp. Example C2 | 3.0 | 1.0 | 3.0 | 1.0 | 2.0 | 3.0 | 3.5 | 1.0 | 17.5 |
| Example 1 | 1.0 | 1.0 | 1.0 | 1.0 | 2.0 | 3.0 | 1.5 | 1.0 | 11.5 |

### DISHWASHING TEST CONDITIONS

Machine: Miele SS-ADW, Model G1222SC Labor 2 (GSL2). Wash at 50° C.-8 min/rinse 65° C. Water: 600 ppm total hardness, Ca:Mg=3:1 Ratio of Deionized water with 300 ppm Na-bicarbonate (TH=37° FH, TAC=23° FH). Food soil: 50 g of the composition noted above in TABLE 3 was introduced to the wash liquor frozen in a cup. Each dishwashing composition from Comparative Example C3 and Example 2 were tested, dosed at 16.15 g per wash.

### FILMING AND SPOTTING EVALUATION

After 15 wash cycles under the above dishwashing test conditions, the glass tumblers, wine glasses, PMMA glasses and stainless steel butter dishes were dried in open air. After drying in open air following the 15^{th} wash, filming and spotting ratings were determined by trained evaluators by observations in a light box with controlled illumination from below. The glass tumblers, wine glasses, PMMA glasses and stainless steel butter dishes were rated for filming and spotting according to ASTM method ranging from 1 (no film/spots) to 5 (heavily filmed/spotted). An average value of 1 to 5 for filming and spotting was determined as reported in TABLE 7.

TABLE 7

| | Fifteen Cycle Score | | | | | | | | |
|---|---|---|---|---|---|---|---|---|---|
| | Glass | | Wine | | PMMA | | SS Butter | | |
| | Tumblers | | Glasses | | Glasses | | Dishes | | Overall |
| Composition | Film | Spot | Film | Spot | Film | Spot | Film | Spot | Shine |
| Comp. Example C3 | 3.5 | 1.0 | 3.5 | 1.0 | 3.0 | 3.5 | 1.5 | 1.5 | 18.5 |
| Example 2 | 2.0 | 1.5 | 2.0 | 1.0 | 2.5 | 3.0 | 1.0 | 2.0 | 15.0 |

### DISHWASHING TEST CONDITIONS

Machine: Miele SS-ADW, Model G1222SC Labor 2 (GSL2). Wash at 65° C.-8 min/rinse 65° C. Water: 600 ppm total hardness, Ca:Mg=3:1 Ratio of Deionized water with 300 ppm Na-bicarbonate (TH=37° FH, TAC=23° FH). Food soil: 50 g of the composition noted above in TABLE 3 was introduced to the wash liquor frozen in a cup. Each dishwashing composition from Comparative Example C3 and Example 2 were tested, dosed at 16.15 g per wash.

### FILMING AND SPOTTING EVALUATION

After 15 wash cycles under the above dishwashing test conditions, the glass tumblers, wine glasses, PMMA glasses and stainless steel butter dishes were dried in open air. After drying in open air following the 15^{th} wash, filming and spotting ratings were determined by trained evaluators by observations in a light box with controlled illumination from below. The glass tumblers, wine glasses, PMMA glasses and stainless steel butter dishes were rated for filming and spotting according to ASTM method ranging from 1 (no film/spots) to 5 (heavily filmed/spotted). An average value of 1 to 5 for filming and spotting was determined as reported in TABLE 8.

TABLE 8

| | Fifteen Cycle Score | | | | | | | | |
|---|---|---|---|---|---|---|---|---|---|
| | Glass | | Wine | | PMMA | | SS Butter | | |
| | Tumblers | | Glasses | | Glasses | | Dishes | | Overall |
| Composition | Film | Spot | Film | Spot | Film | Spot | Film | Spot | Shine |
| Comp. Example C3 | 3.5 | 1.0 | 3.5 | 1.0 | 3.5 | 3.0 | 3.0 | 1.0 | 19.5 |
| Example 1 | 2.5 | 1.0 | 1.5 | 1.0 | 3.5 | 3.0 | 1.5 | 1.0 | 15.0 |

We claim:

1. An automatic dishwashing composition, comprising:
(a) a builder;
(b) a nonionic surfactant;
(c) a first dispersant polymer comprising:
(i) 60 to 98 wt %, based on solids weight of the first dispersant polymer, of structural units of formula I 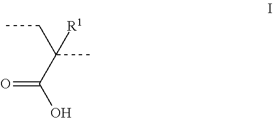
wherein each R′ is independently selected from a hydrogen and a —CH₃ group; and
(ii) 2 to 40 wt %, based on solids weight of the first dispersant polymer, of structural units of formula II 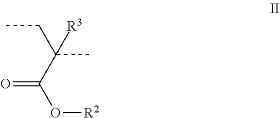
wherein each R² is independently selected from a —C₁₋₄ alkyl group and wherein each R³ is independently selected from a hydrogen and a methyl group; and
(d) a second dispersant polymer comprising:
(i) 60 to 98 wt %, based on solids weight of the second dispersant polymer, of structural units of formula I; wherein each R¹ is independently selected from a hydrogen and a —CH₃ group; and
(ii) 2 to 40 wt %, based on solids weight of the second dispersant polymer, of structural units of formula II; wherein each R² is independently selected from a —C₁₋₄ alkyl group and wherein each R³ is independently selected from a hydrogen and a methyl group;
wherein the first dispersant polymer and the second dispersant polymer are different.

2. The automatic dishwashing composition of claim 1, wherein the first dispersant polymer comprises: (i) 60 to 80 wt %, based on solids weight of the first dispersant polymer, of structural units of formula I; wherein each R¹ is independently selected from a hydrogen and a —CH₃ group; and (ii) 20 to 40 wt %, based on solids weight of the first dispersant polymer, of structural units of formula II; wherein each R² is independently selected from a —C₁₋₄ alkyl group and wherein each R³ is independently selected from a hydrogen and a methyl group; and
wherein the second dispersant polymer comprises: (ii) >80 to 98 wt %, based on solids weight of the second dispersant polymer, of structural units of formula I; wherein each R¹ is independently selected from a hydrogen and a —CH₃ group; and (b) 2 to <20 wt %, of structural units of formula II; wherein each R² is independently selected from a —C₁₋₄ alkyl group and wherein each R³ is independently selected from a hydrogen and a methyl group.

3. The automatic dishwashing composition of claim 2, wherein the first dispersant polymer has a weight average molecular weight of 4,000 to 50,000 Daltons; and
wherein the second dispersant polymer has a weight average molecular weight of 1,000 to <4,000 Daltons.

4. The automatic dishwashing composition of claim 3, wherein the builder includes a mixture of at least one carbonate and at least one citrate.

5. The automatic dishwashing composition of claim 4, further comprising a phosphonate.

6. The automatic dishwashing composition of claim 5, wherein the automatic dishwashing composition contains less than 0.1 wt %, based on the dry weight of the automatic dishwashing composition, of phosphate, measured as elemental phosphorus.

7. The automatic dishwashing composition of claim 6, wherein the automatic dishwashing composition contains 0 wt %, based on the dry weight of the automatic dishwashing composition, of builders selected from the group consisting of nitrilotriacetic acid; ethylenediaminetetraacetic acid; diethylenetriaminepentaacetic acid; glycine-N,N-diacetic acid; methyl glycine-N,N-diacetic acid; 2-hydroxyethyliminodiacetic acid; glutamic acid-N,N-diacetic acid; 3-hydroxy-2,2′-iminodissuccinate; S,S-ethylenediaminedisuccinate aspartic acid-diacetic acid; N,N′-ethylene diamine disuccinic acid; iminodisuccinic acid; aspartic acid; aspartic acid-N,N-diacetic acid; beta-alaninediacetic acid; polyaspartic acid; salts thereof and mixtures thereof.

8. The automatic dishwashing composition of claim 7, further comprising an additive selected from the group consisting of a bleaching agent, a bleach activator, an enzyme, a filler, and mixtures thereof.

9. The automatic dishwashing composition of claim 8, comprising:
40 to 70 wt %, based on the dry weight of the automatic dishwashing composition, of the builder, wherein the builder is selected from the group consisting of carbonates, bicarbonates, citrates, silicates and mixtures thereof;
5 to 17.5 wt %, based on the dry weight of the automatic dishwashing composition, of the nonionic surfactant; wherein the nonionic surfactant comprises a mixture of nonionic alcohol alkoxylate surfactants;
2 to 4 wt %, based on the dry weight of the automatic dishwashing composition, of the first dispersant polymer; wherein R¹ is a hydrogen in at least 98 mol % of the structural units of formula I; and wherein R² is an ethyl group in at least 98 mol % of the structural units of formula II and wherein R³ is a hydrogen in at least 98 mol % of the structural units of formula II; and
2 to 4 wt %, based on dry weight of the automatic dishwashing composition, of the second dispersant polymer; wherein R¹ is a hydrogen in at least 98 mol % of the structural units of formula I; and wherein R² is an ethyl group in at least 98 mol % of the structural units of formula II and wherein R³ is a hydrogen in at least 98 mol % of the structural units of formula II;
2 to 7.5 wt %, based on the dry weight of the automatic dishwashing composition, of the phosphonate;
5 to 12 wt %, based on the dry weight of the automatic dishwashing composition, of a bleaching agent, selected from the group consisting of sodium percarbonate and sodium perborate;
2.5 to 7.5 wt %, based on the dry weight of the automatic dishwashing composition, of a bleach activator; wherein the bleach activator is tetraacetylethylenediamine;
3 to 6 wt %, based on the dry weight of the automatic dishwashing composition, of a protease; and
2.5 to 4.5 wt %, based on the dry weight of the automatic dishwashing composition, of an amylase.

10. A method of cleaning an article in an automatic dishwashing machine, comprising:
providing at least one article;
providing an automatic dishwashing composition according to claim 1; and,
applying the automatic dishwashing composition to the at least one article.
